(19) United States
(12) Patent Application Publication
(10) Pub. No.: US 2006/0241362 A1
(43) Pub. Date: Oct. 26, 2006

(54) Method and device for the mapping of intraretinal ph and device for the photocoagulation of peripheral retinal areas

(75) Inventors: Serge Mordon, Villeneuve d'Ascq (FR); Philippe Rochon, Sin Le Noble (FR)

Correspondence Address: MILLER, MATTHIS & HULL, ONE NORTH FRANKLIN STREET, SUITE 2350, CHICAGO, IL, 60606, US

(73) Assignee: Institut National de la Sante et de la Recherche Medicale (INSERM), Paris (FR)

(21) Appl. No.: 10/548,914

(22) PCT Filed: Mar. 5, 2004
(86) PCT No.: PCT/FR04/00534

§ 371 Date: Jun. 21, 2006

(30) Foreign Application Priority Data
Mar. 14, 2003 (FR) 0303174

(51) Int. Cl. A61H 33/00

(52) U.S. Cl. 600/315; 607/87

(57) ABSTRACT

The invention relates to a method of mapping the intraretinal pH of a retina which is marked by a pH-dependent fluorescent marker, in which the retina is illuminated with a first excitation radiation. According to the invention, a first image of the fluorescence emitted by the retina is formed as a bi-directional matrix of pixels at the wavelength of the peak of the fluorescence emission spectrum. Subsequently, the retina is illuminated with a second excitation radiation and a second image is formed of the fluorescence emitted thereby. Finally, the ratio at each pixel between the levels of fluorescence emitted in response to the two respective wavelengths is calculated, said ratio being representative of the pH of the retina, and a pH map of the retina is deduced.

The present invention relates to the field of intraretinal mapping.

Intraretinal mapping is usually carried out by angiography or by taking photographs of the fundus of the eye. However, these techniques provide results that are qualitative and sometimes difficult to interpret. Moreover, document WO92/12412 discloses a device and a method of measuring the pH of a target, which can be used endoscopically, using fluorescent markers. The method disclosed in that document overcomes measurement condition problems by working with ratios of fluorescence levels (and not with fluorescence levels themselves). However, it is not possible to map the pH, in two dimensions, of a target area.

The object of the present invention is to provide a noninvasive method and device for the fluorescence mapping of the intraretinal pH which employ only well-controlled techniques and means and which provide a faithful representation that can be used directly for subsequent diagnostic purposes.

According to a first aspect, the invention proposes a method of mapping the intraretinal pH, whereby, after the retina has been marked by a fluorescent marker, the fluorescence emission spectrum of which has a peak whose amplitude depends on the pH:

a) the retina is illuminated with first excitation radiation having a narrow spectrum centered on a wavelength falling within the excitation spectrum of the fluorescent marker, and a first image of the fluorescence emitted by the retina is formed, in the form of a two-directional matrix of pixels, at the wavelength of the peak of the fluorescence emission spectrum;

b) the retina is illuminated with second excitation radiation having a narrow spectrum centered on a wavelength of the excitation spectrum of the fluorescent marker that is different from that of the first radiation, and a second image of the fluorescence emitted by the retina is formed, in the form of a two-dimensional matrix of pixels, at the wavelength of the peak of the fluorescence emission spectrum; and

c) the ratio of the fluorescence levels emitted in response to the two respective excitation wavelengths at each pixel is calculated, this ratio being representative of the pH of the retina, and a pH map of the retina is deduced therefrom.

According to a second aspect, the invention proposes a method of mapping the intraretinal pH, after the retina has been marked with a fluorescent marker, the fluorescence emission spectrum of which has a peak whose amplitude depends on the pH. This method involves only a single excitation radiation and comprises the following steps:

a) the retina is illuminated with excitation radiation having a narrow spectrum centered on a wavelength falling within the excitation spectrum of the fluorescent marker;

b) a first image of the fluorescence emitted by the retina is formed, in the form of a two-dimensional matrix of pixels, at the wavelength of the peak of the fluorescence emission spectrum;

c) a second image of the fluorescence emitted by the retina is formed, in the form of a two-dimensional matrix of pixels, at a wavelength corresponding to an isosbestic point in the fluorescence emission spectrum; and

d) the ratio of the fluorescence levels emitted at the two respective wavelengths falling within the emission spectrum at each pixel is calculated, this ratio being representative of the pH of the retina, and a pH map of the retina is deduced therefrom.

According to a third aspect, the invention relates to a device for mapping the intraretinal pH of a retina marked with a fluorescent marker, the fluorescence emission spectrum of which has an intensity peak whose height depends on the pH.

It is known that retinal ischemia, which is characterized among other things by acidification of the internal neuroretina, may lead to the formation of retinal neovessels. These retinal vessels may bleed, fibrose and cause problems of significant reduction in visual acuity. The use of a method and a device according to the invention allows better quantification of the ischemia than the methods and procedures of the prior art, and facilitates diagnosis by a practitioner and makes it easier to determine indications for subsequent treatment.

According to a fourth aspect, the invention relates to a device for photocoagulating the peripheral areas of a retina, which device may incorporate the elements of the mapping device. This photocoagulation device comprises the same elements as the intraretinal pH mapping device and a laser provided with means for focusing and orienting an output beam onto the point or points on the retina that are represented, on the pH mapping image provided by the device, by pixels corresponding to pH values below a given threshold value.

Other features and advantages of the invention will become apparent over the course of the following description of embodiments, these being given by way of nonlimiting example and with reference to the appended drawings.

In the drawings:

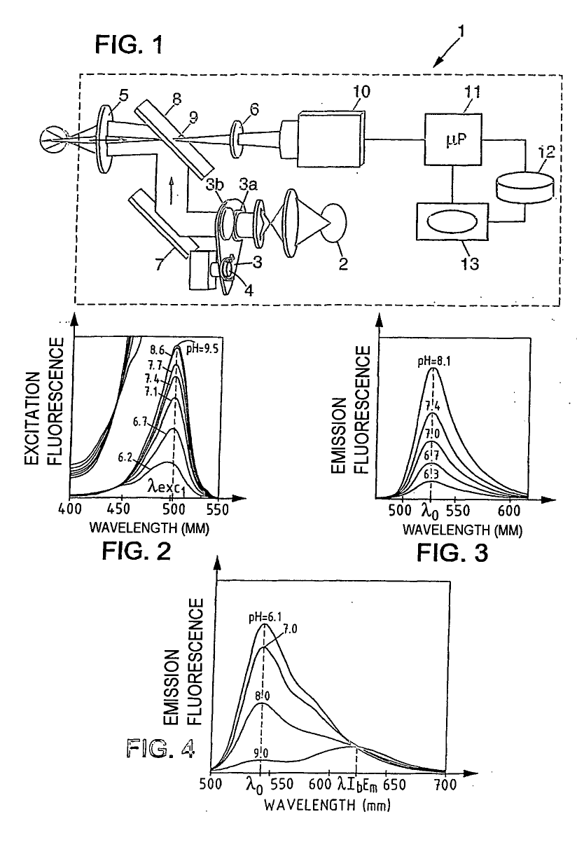

FIG. 1 is a schematic view of one embodiment of an intraretinal pH mapping device in one way of implementing the invention;

FIG. 2 shows the fluorescence excitation spectrum of BCECF as a function of pH;

FIG. 3 shows the emission fluorescence spectrum of BCECF as a function of pH;

FIG. 4 shows the emission fluorescence spectrum of SNAFL-1 as a function of pH;

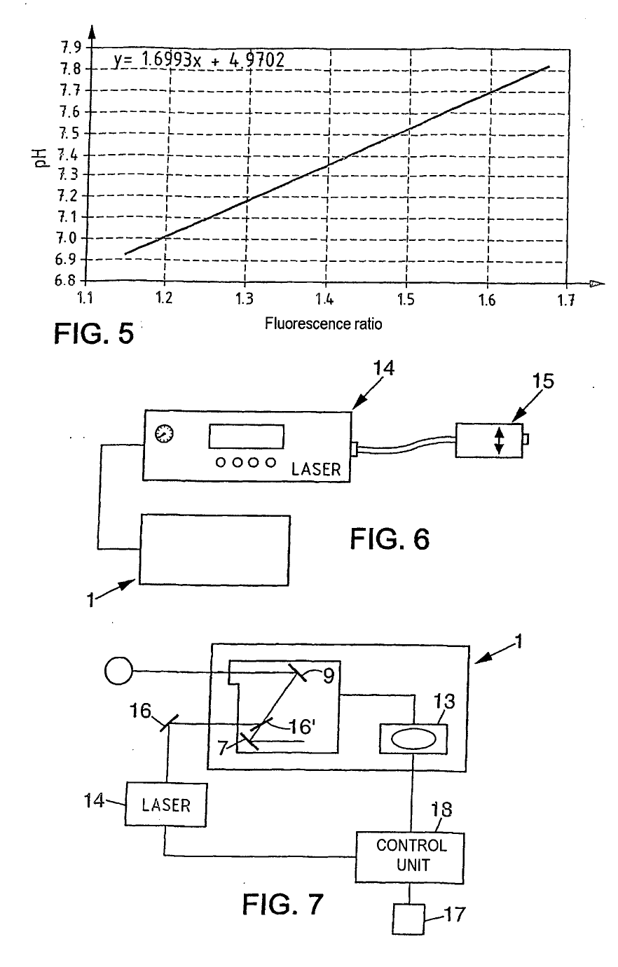

FIG. 5 is a curve showing the correspondence between the fluorescence ratios and pH;

FIG. 6 is a schematic view of a device for coagulating the peripheral areas of the retina according to the invention; and

FIG. 7 is a schematic view of another photocoagulation device according to the invention.

In the various figures, the same references denote identical or similar elements.

FIG. 1 shows a schematic view of a device 1 for mapping the intraretinal pH of a retina marked with a fluorescent marker in one embodiment of the invention, which includes a light source 2 whose radiation spectrum contains at least part of the excitation spectrum of the fluorescent marker used. This light source 2 is associated with a filter system 3. This filter system comprises two filters 3a and 3b, which can be selected successively. These filters 3a and 3b are narrow-band filters, each centered on a separate wavelength, λ_{exc1} and λ_{exc2} respectively, of the excitation spectrum of the fluorescent marker. Switching from one filter to the other is accomplished by actuating an arm 4 that carries the two filters.

The source 2 is for example a xenon lamp. The power is for example 150 W. The band of the filters 3a and 3b nm has for example a width at mid-height of 10 nm. It would also be possible to use, instead of the source 2 associated with the filter system 3, laser diodes of respective wavelength λ_{exc1} and λ_{exc2}.

The device 1 furthermore includes a focusing optic 5 for focusing the radiation onto the human retina.

Along the return path of the light, the device includes a filter 6 designed to let through only a narrow band containing the wavelength λ₀ of the peak of the fluorescence emission spectrum, which corresponds to the peak in pH sensitivity. This filter thus receives the fluorescence from the retina illuminated by the light source.

In one advantageous method of implementation, the device is incorporated into an angioretinography device and furthermore includes two mirrors 7, 8 for folding the return path. An aperture 9 in the mirror 8 allows the emission fluorescence to pass through it, allowing the incident channel to be separated from the return channel of the retina.

The device 1 furthermore includes a matrix camera 10 for forming a 2D image. This camera provides an image with, at each pixel, a value representative of the fluorescence level.

The device also includes means 11 for calculating the ratio of the values at each pixel for two images provided. It is also provided with means 12 for storing these values. In general, the device 1 also includes means 13 for displaying an image.

The camera may for example be a CCD camera, sensitive for wavelengths of the emission spectrum of BCECF. It may comprise 512×512 pixels. The calculating means 11, storage means 12 and display means 13 are for example the microprocessor, the hard disk and the monitor of a computer.

The first mapping method according to the invention is carried out in one implementation as follows. A fluorescent marker, whose fluorescence depends on the pH, is injected beforehand into a vein. Many pH-dependent fluorescent markers can be used (SNAFL, SNARF, HPTS, fluoresceins and carbofluoresceins, etc.). The method of implementation shown below uses BCECF(2′,7′-bis(2-carboxyethyl) 5(and 6)carboxyfluorescein), the sensitivity range of which lies within physiological pH values. BCPCF (2′,7′-bis(2-carboxypropyl)-5(and 6)carboxyfluorescein) may also be used. BCPCF is a derivative of BCECF in which the carboxyethyl group has been replaced with a carboxypropyl group. BCPCF has a wavelength at the isosbestic point of the excitation spectrum of 454 nm and a wavelength at the isosbestic point of the emission spectrum of 504 nm.

The amount of BCECF injected lies for example within the range from 0.1 to 10 mg per kg of the patient's body. In the method of implementation shown below, this amount is 1 mg/kg.

Once sufficient time has elapsed after injection for the retina to have received the marker, the retina is illuminated with first excitation radiation having a narrow spectrum (mid-height width of 10 nm) centered on a wavelength λ_{exc1} of the excitation spectrum of the fluorescent marker. This radiation corresponds to the radiation of the light source 2 filtered by the first filter of wavelength λ_{exc1} of the filter system 3. A first image of the fluorescence emitted by the retina is formed simultaneously on the sensitive member of the camera 10. This first image, in the form of a two-dimensional matrix of pixels, represents the fluorescence from the retina filtered by the filter system 6 at the wavelength λ₀. This image is stored in digital form in the storage means 12.

FIG. 2 shows the excitation fluorescence spectrum of BCECF as a function of pH. It shows the changes in the fluorescence effect at the various excitation wavelengths.

FIG. 3 shows the emission spectrum of BCECF as a function of pH, the spectrum having a peak at a wavelength λ₀.

Advantageously, λ_{exc1} is equal to the wavelength of the peak of the excitation spectrum of the fluorescent marker. In the case of BCECF, the excitation spectrum of which is shown in FIG. 2, λ_{exc1} may therefore be taken to be equal to 490 nm.

The first filter is then replaced with the second filter, centered on λ_{exc2}, by moving the arm 4. The retina is illuminated with second excitation radiation having a narrow spectrum centered on the wavelength λ_{exc2} of the excitation spectrum of the fluorescent marker that is different from that of the first radiation. A second image of the fluorescence emitted by the retina is formed, in the form of a two-dimensional matrix of pixels, again at the wavelength λ₀.

For example, λ_{exc2} may be taken to be equal to 470 nm.

Advantageously, in another method of implementing the invention, λ_{exc2} may also be chosen to be equal to the 450 nm wavelength of the isosbestic point of the excitation spectrum (the point having the same level of absorption whatever the pH) shown in FIG. 2.

The microprocessor 11 calculates, at each pixel, the ratio of the fluorescence levels at the wavelength λ₀, after possible storage, emitted in response to the two respective excitation wavelengths λ_{exc1} and λ_{exc2}.

Finally, a pH map of the retina is determined from this ratio, which is representative of the pH of the retina. This image may be displayed on the screen 13.

The pH measurement is reliable and not dependent on the measurement conditions, as it uses a fluorescence intensity ratio for two different excitation wavelengths. The pH value is obtained from the calculated fluorescence ratio, using a predetermined ratio/pH correspondence curve.

In another method of implementing the invention, a device according to an alternative embodiment is used in which the filter system 3 includes at least one narrow-band filter (mid-height width of 10 nm) centered on a wavelength λ_{exc} of the excitation spectrum of the fluorescent marker. The device includes a filter system, instead of the filter 6, suitable for filtering in succession, at two different wavelengths, λ₀ and λ_{IbEm} respectively, the fluorescence from the retina illuminated by the light source. λ₀ and λ_{IbEm} correspond to the wavelength of the peak and the wavelength of the isosbestic point, respectively, of the fluorescence emission spectrum. FIG. 4 shows the emission spectrum of the fluorescent marker SNAFL-1 for which λ₀=540 nm and λ_{IbEm}=635 nm. The same system as previously may be used to switch from one filter to the other.

The method employing this latter device is as follows.

A pH-dependent fluorescent marker is injected. The retina is then illuminated with excitation radiation having a narrow spectrum (typically a mid-height width of 10 nm) centered on the wavelength λ_{exc} of the excitation spectrum of the fluorescent marker, using the light source 2, the emission from which is filtered by the filter 3 centered on the wavelength λ_{exc}. The camera 10 forms a first image of the fluorescence emitted by the retina, in the form of a two-dimensional matrix of pixels, at the wavelength λ₀ of the peak of the fluorescence emission spectrum. The corresponding data is stored by the storage means 12.

The first filter of the filter system is then replaced with the second filter centered on λ_{IbEm} and a second image of the fluorescence emitted by the retina is formed, in the form of a second two-dimensional matrix of pixels, at the wavelength λ_{IbEm} corresponding to the isosbestic point of the emission spectrum.

Advantageously, an optical system may be used that allows the CCD camera to form both images of the fluorescence.

Finally, a pH map of the retina is determined from the calculated ratio, at each pixel, of the fluorescence levels emitted at the two wavelengths of the fluorescence emission spectrum, this ratio being representative of the pH of the retina.

In one advantageous method of implementing the invention, the wavelength corresponding to the excitation spectrum peak may be chosen as the excitation wavelength λ_{exc}.

For example, if the fluorescent marker C-SNAFL-1 is used, the method described above may be implemented using a single excitation at 514 nm and by forming two images corresponding to the fluorescence at the respective wavelengths of 540 nm and 635 nm.

In a method according to the invention, the measurements are carried out after injection within a period lying between a minimum of three minutes and a maximum of three hours, usually a few minutes.

A look-up table showing the correspondence between fluorescence ratios and pH may for example be established by means of a prior measurement, reproducing the planned conditions of use, by comparison with the data provided by a pH electrode on similar tissue and under illumination conditions identical to those of the measurements that will be carried out using the method. FIG. 6 gives an example of a correspondence curve established as a result of such a prior measurement. Other principles known for establishing this correspondence also exist, for example that presented in the article “Fluorescence Behavior of Single-Molecule ph Sensors” by S. Brasselet and W. E. Moerner, Research Paper, Single Molecules (2000).

The device may be supplemented with means for photocoagulating areas of the retina based on the intraretinal pH mapping according to the invention, by adding a treatment laser to the mapping device.

By photocoagulating areas of the retina, especially the peripheral areas, it is possible to destroy the isochemic areas which lead to the formation of neovessels.

The procedure, using the device shown in FIG. 6, may be carried out as follows: after having placed a drop of anesthetic eye lotion in the eye, the pH of the eye is mapped using one of the methods of the invention, by means of the device 1 shown in FIG. 1.

The pixels corresponding to those points on the retina whose pH is below a given threshold are then identified and a laser pulse is directed onto only those points.

The pH threshold in question is for example equal to 7.2. These points on the retina, which correspond to the isochemic areas, are treated with the laser.

To do this, in the case shown in FIG. 6, a laser 14, coupled to the intraretinal pH mapping device 1, is used, the output power and the pulse width of the laser 14 being able to be adjusted and the laser 14 being provided with focusing and directing means 15. The laser may for example be directed using a control lever onto the identified points on the retina, through a slit lamp or a biomicroscope, either of which is connected to the laser.

The laser may also be coupled directly to the retinograph used in the embodiment of the device 1 described above.

FIG. 7 shows a photocoagulation device in one embodiment of the invention. The laser is in this case directly coupled, via additional folding mirrors 16 and 16′ to the retinograph, which forms part of the mapping device 1 described above in one method of implementing the invention. In FIG. 7, only the display screen 13 and the mirrors 7 and 9 of the device 1 have been shown. A control lever or mini-joystick 17 connected to a control unit 18, which is itself connected to the display screen 13, for example the screen of the retinograph, is used to move the laser beam over the area whose pH is displayed in real time on the screen 13.

The laser may for example be a green monochromatic argon laser or a 532 nm frequency-doubled Nd:YAG laser.

In the case of retina opacity, a krypton laser may be used. The impacts on points identified on the map are defined by the focusing means between 200 μm and 500 μm in diameter, generally with an exposure time of 0.1 to 0.2 s.

The power of the laser used is for example 100 to 500 mW and it is adjusted according to the effect and also according to any possible cataract that attenuates the laser beam. Four to six sessions, each consisting of 500 impacts, may be carried out, seeking to obtain a retina of clean white appearance.

1. A method of mapping the intraretinal pH of a retina marked with a fluorescent marker, the fluorescent marker having a fluorescence emission spectrum with a pH-dependent amplitude and a peak at a peak wavelength, the method comprising the steps of:
a) illuminating the retina with first excitation radiation having a narrow spectrum centered on a first wavelength falling within an excitation spectrum of the fluorescent marker, and forming a first image of the fluorescence emitted by the retina at the peak wavelength, in the form of a two-dimensional matrix of pixels;
b) illuminating the retina with second excitation radiation having a narrow spectrum centered on a second wavelength falling within the excitation spectrum of the fluorescent marker and different from the first wavelength, and forming a second image of the fluorescence emitted by the retina at the peak wavelength, in the form of a two-dimensional matrix of pixels; and
c) calculating a ratio of fluorescence levels respectively emitted in response to the first and second excitation wavelengths at each pixel, said ratio being representative of the pH of the retina, and deriving therefrom a pH map of the retina.

2. The method as claimed in claim 1, wherein the first wavelength corresponds to a peak of an absorption spectrum of the fluorescent marker.

3. The method as claimed in claim 1, wherein the second wavelength corresponds to an isosbestic point of the excitation spectrum of the fluorescent marker.

4. A method of mapping the intraretinal pH of a retina marked with a fluorescent marker, the fluorescent marker having a pH-dependent fluorescence emission spectrum and a peak at a peak wavelength, the method comprising the steps of:
a) illuminating the retina with excitation radiation having a narrow spectrum centered on a wavelength falling within an excitation spectrum of the fluorescent marker;
b) forming a first image of the fluorescence emitted by the retina at a first wavelength corresponding to the peak wavelength, in the form of a two-dimensional matrix of pixels;
c) forming a second image of the fluorescence emitted by the retina at a second wavelength corresponding to an isosbestic point in the fluorescence emission spectrum, in the form of a two-dimensional matrix of pixels; and
d) calculating a ratio of the fluorescence levels respectively emitted at the first and second wavelengths at each pixel, said ratio being representative of the pH of the retina, and deriving therefrom a pH map of the retina.

5. The method as claimed in claim 4, wherein the excitation radiation is centered on a wavelength corresponding to a peak of an absorption spectrum of the fluorescent marker.

6. A device for mapping the intraretinal pH of a retina marked with a fluorescent marker, the fluorescent marker having a fluorescence emission spectrum with a peak, of pH-dependent height at a peak wavelength, the device comprising:
a light source having means for selecting only one or two successive different wavelengths of an excitation spectrum of the fluorescent marker;
a focusing optic for focusing the radiation onto the retina;
filtering means for filtering, at one or more given wavelengths, the fluorescence emission spectrum of the retina illuminated by the light source;
a matrix camera for forming a two-dimensional image with, at each pixel, a pixel value representative of the fluorescence level;
means for storing the pixel values;
means for calculating the ratio of the pixel values at each pixel for two images provided; and
means for displaying an image, in which each pixel has a respective value representing the calculated ratio, representative of the pH of a point on the retina represented by said pixel.

7. The device as claimed in claim 6, wherein the means for selecting are arranged to select at least one wavelength corresponding to a peak of the absorption spectrum of the fluorescent marker.

8. The device as claimed in claim 6, wherein the means for selecting are arranged to select at least one wavelength corresponding to an isosbestic point of the absorption spectrum of the fluorescent marker.

9. The device as claimed in claim 6, wherein the filtering means comprise a filter designed to filter at the peak wavelength.

10. The device as claimed in claim 6, wherein the filtering means comprise a filter designed to filter at a wavelength of an isosbestic point of the fluorescence emission spectrum.

11. A device for photocoagulating peripheral areas of a retina, which comprises:
a device for mapping the intraretinal pH as claimed in claim 6; and
a laser provided with means for focusing and orienting an output beam onto the point or points on the retina that are represented, on a pH mapping image provided by the mapping device, by pixels corresponding to pH values below a given threshold value, wherein the mapping device comprises:
a light source having means for selecting only one or two successive different wavelengths of an excitation spectrum of a fluorescent marker, the fluorescent marker having a fluorescence emission spectrum with a peak of pH-dependent height at a peak wavelength;
a focusing optic for focusing radiation from the light source onto the retina marked with the fluorescent marker;
filtering means for filtering, at one or more given wavelengths, the fluorescence emission spectrum of the retina illuminated by the light source;
a matrix camera for forming a two dimensional image with, at each pixel, a pixel value representative of the fluorescence level;
means for storing the pixel values;
means for calculating the ratio of the pixel values at each pixel for two images provided; and
means for outputting the mapping image in which each pixel has a respective value representing the calculated ratio, representative of the pH of a point on the retina represented by said pixel.

12. The device as claimed in claim 11, wherein the means for selecting are arranged to select at least one wavelength corresponding to a peak of the absorption spectrum of the fluorescent marker.

13. The device as claimed in claim 11, wherein the means for selecting are arranged to select at least one wavelength corresponding to an isosbestic point of the absorption spectrum of the fluorescent marker.

14. The device as claimed in claim 11, wherein the filtering means comprise a filter designed to filter at the peak wavelength.

15. The device as claimed in claim 11, wherein the filtering means comprise a filter designed to filter at a wavelength of an isosbestic point of the fluorescence emission spectrum.
